(19) United States
(12) Patent Application Publication
(10) Pub. No.: US 2015/0110963 A1
(43) Pub. Date: Apr. 23, 2015

(54) Multifunctional Composition and Method For Treating a Metal Surface With the Multifunctional Composition

(71) Applicant: Lonza Inc., Allendale, NJ (US)

(72) Inventors: Xiao Jiang, Montvale, NJ (US); David Biro, Rockway, NJ (US); Edwin Holcombe, Johns Creek, GA (US)

(21) Appl. No.: 14/509,590

(22) Filed: Oct. 8, 2014

Related U.S. Application Data
(60) Provisional application No. 61/894,181, filed on Oct. 22, 2013.

(51) Int. Cl. C09D 5/08

(52) U.S. Cl. CPC C09D 5/08
USPC 427/402; 106/14.42

(57) ABSTRACT

The present invention is directed to an anticorrosion composition and a method for preventing or inhibiting the corrosion of a metal substrate utilizing an anticorrosion compound. The method utilizes an anticorrosion composition comprising at least one amine oxide and at least one N-containing compound. The invention relates to a method for inhibiting the corrosion of metal surfaces by applying the composition to a metal substrate. The composition of the present invention provides corrosion inhibition, cleaning capabilities, and conversion capabilities.

### CROSS-REFERENCE TO RELATED APPLICATIONS

The present application claims priority to U.S. Provisional Application Ser. No. 61/894,181 having a filing date of Oct. 22, 2013, which is incorporated herein by reference in its entirety.

### BACKGROUND

Metals are important materials that are used in a variety of applications. For instance, metals are commonly used in manufacturing and construction for housing materials, automobile parts, industrial machinery, etc. Generally, when metals come into contact with water or moisture, they have a tendency to corrode. While this may be a problem in and of itself, it may be more problematic if the metal is originally prone to corrosion or is not coated to prevent or inhibit corrosion.

Anticorrosive coatings on metals, also known as conversion coatings, are generally used to inhibit corrosion. In the past, coatings comprising chromate or phosphates were chemically reacted with a steel surface to form a rough surface that provided both mechanical and chemical adhesion of the organic polymer to the surface. See, for example, Watson, J. “A Refresher: Understanding Pretreatment,” Powder Coating 1996, 7(3) and Ferguson, D.; Monzyk, B., “Nonpolluting replacement for chromate conversion coating and zinc phosphate in powder coating applications,” Powder Coating 2001, 12(7). However, these coatings comprise chromates and phosphates and thus raise health and environmental concerns.

In addition, processes for applying these types of coatings require several steps. For instance, some processes require that the metal surface be cleaned to remove grease and/or particles before applying the coatings. Similarly, the metal surface may be passivated with oil to prevent flash rust. As such, because of the additional steps involved, these processes may also require greater amounts of industrial effluents and solvents which must be disposed.

Additionally, other anticorrosive agents or inhibitors have been known for years but are still inadequate. In some formulations, formaldehyde or compounds that give off formaldehyde have been used to provide corrosion protection. However, formaldehyde readily evaporates from the composition and contaminates the surrounding air. Other formulations may require compounds that promote undesired reactions with other acids and surfactants that may be present.

Furthermore, because of concerns about volatile organic carbons, some formulations have replaced organic solvents with water. However, one inadequacy that has resulted is that of water solubility. For instance, some compositions are produced from components that exhibit poor aqueous solubility. This may make application of the composition difficult for forming a coating. Additionally, the application of water may even promote rust formation or corrosion of the metal itself. Furthermore, water may not solubilize grease or oil residues easily from the metal surfaces.

Consequently, there is a need for an improved corrosion inhibitor that prevents or inhibits corrosion on metal surfaces. In particular, there is a need for a coating that provides a protective barrier film or layer on the metal substrate that is capable of corrosion inhibition and paint adhesion. In addition, there is a need for corrosion inhibitors that possess good affinity for metallic surfaces and are water soluble. Furthermore, there is a need for providing an anticorrosion coating utilizing minimum steps and a less complex process.

### SUMMARY

In general, the present disclosure is directed to an anticorrosion compound and a method for inhibiting the corrosion of metals. The method comprises contacting a metal substrate with an anticorrosive composition. The composition is comprised of at least one amine oxide and at least one N-containing compound.

The amine oxide has the following formula

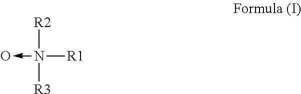

R1 is a linear, branched, or cyclic C₆₋₄₀ saturated or unsaturated group.

R2 and R3 are each independently of one another H or a linear, branched, or cyclic C₁₋₄₀ saturated or unsaturated group

The N-containing compound has the following formula:

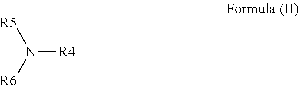

R4 is a linear, branched, or cyclic C₁₋₄₀ saturated or unsaturated group.

R5 and R6 are each independently of one another H or a linear, branched, or cyclic C₁₋₄₀ saturated or unsaturated group or R5 and R6 are both taken together in combination with the N to which they are attached to form a cyclic or heterocyclic group, optionally substituted.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 illustrates a corrosion test comparing the effect of one composition of the present disclosure, deionized water, and a commercially available anticorrosion agent on carbon steel coupons;

FIG. 2 illustrates a corrosion test comparing the effect of another composition of the present disclosure, deionized water, and a commercially available anticorrosion agent on carbon steel coupons;

FIG. 3 illustrates a corrosion test comparing the effect of another composition of the present disclosure, deionized water, and a commercially available anticorrosion agent on carbon steel coupons;

FIG. 4 illustrates a carbon steel coupon exposed to deionized water and a carbon steel coupon exposed to another composition of the present disclosure; and

FIG. 5 illustrates a corrosion test comparing the effect of three individual compositions of the present disclosure and deionized water on carbon steel coupons.

Repeat use of reference characters in the present specification and drawings is intended to represent the same or analogous features or elements of the present invention.

### DETAILED DESCRIPTION

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment. Thus, it is intended that the present invention cover such modifications and variations.

In general, the present disclosure is directed to a multifunctional composition and a method for treating a metal substrate with the multifunctional composition for preventing or inhibiting corrosion. Generally, corrosion may be prevented or inhibited by using a multifunctional, anticorrosive composition to provide an anticorrosive coating or a conversion coating. The multifunctional composition of the present disclosure is comprised of at least one amine oxide and at least one N-containing compound, the structures of which are further defined below.

The present inventors have discovered that the multifunctional composition, when applied to a metal surface or substrate, presents several advantages. For instance, the composition may provide a coating that inhibits corrosion. In addition, the composition may also provide cleaning and conversion capabilities for the treatment of a metal substrate or surface. As such, the compositions may improve the dimensional stability and appearance of the metals to which they are applied thus maintaining the integrity of these structures. In addition, the composition may provide good lubricity and cooling during metalworking processes.

According to the present disclosure, the composition is comprised of at least one amine oxide. The amine oxide may have the following general formula identified as Formula (I):

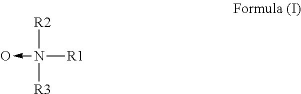

R1 may be a linear, branched, cyclic, or any combination thereof of a C₆₋₄₀ saturated or unsaturated group, such as a C₆₋₂₂ saturated or unsaturated group, such as a C₆₋₁₈ saturated or unsaturated group, such as a C₁₀₋₁₆ saturated or unsaturated group. R1 may be an alkyl group, an alkenyl group, or an alkynyl group.

R2 and R3 each independently of one another may be a H or a linear, branched, cyclic, or any combination thereof of a C₁₋₄₀ saturated or unsaturated group, such as a C₁₋₂₀ saturated or unsaturated group, such as a C₁₋₁₀ saturated or unsaturated group, such as a C₁₋₅ saturated or unsaturated. R2 and R3 each independently of one another may be a H or an alkyl group, an alkenyl group, an alkynyl group, a hydroxyalkyl group, an alkoxy group, or an aminoalkyl group. In one embodiment, R2 and R3 may be different. In another embodiment, R2 and R3 may be the same. For instance, in one embodiment, R2 and R3 may both, as just one example, be a C₁₋₅ alkyl group such as a methyl group.

The alkyl groups, alkenyl groups, alkynyl groups, hydroxyalkyl groups, alkoxy groups, and aminoalkyl groups may be any groups known in the art. For instance, the alkyl groups may include, but are not limited to methyl, ethyl, propyl, isopropyl, butyl, isobutyl, sec-butyl, tert-butyl, pentyl, isopentyl, hexyl, heptyl, octyl, nonyl, isononyl, decyl, dodecyl, tetradecyl, hexadecyl, octadecyl and icosyl, and the like. The hydroxyalkyl groups may include, but are not limited to, hydroxymethyl, hydroxylethyl, hydroxypropyl, etc. The alkoxy groups may include, but are not limited to, methoxy, ethoxy, butoxy, etc. The aminoalkyl groups may include, but are not limited to, methylamine, ethylamine, propylamine, etc. However, it should be understood that the groups are not limited to those listed. These groups may include any number of carbons within the C₆₋₄₀ saturated or unsaturated groups as defined for R1 and within the C₁₋₄₀ saturated or unsaturated groups as defined for R2 and R3.

The amine oxide of the present disclosure may be a C₆₋₂₂ alkyldimethylamine oxide, such as a C₆₋₁₈ alkyldimethylamine oxide, such as a C₁₆₋₁₈ alkyldimethylamine oxide or such as a C₁₀₋₁₄ alkyldimethylamine oxide, such as a C₁₂₋₁₄ alkyldimethylamine oxide, or any combination thereof.

For instance, specific examples of amine oxides that may be used according to the present disclosure include, but are not limited to, hexyldimethylamine oxide, heptyldimethylamine oxide, octyldimethylamine oxide, nonyldimethylamine oxide, n-decyldimethylamine oxide, undecyldimethylamine oxide, isododecyldimethylamine oxide, n-dodecyldimethylamine oxide, cocodimethylamine oxide, myristyldimethylamine oxide, isotridecyldimethylamine oxide, tetradecyldimethylamine oxide, lauryldimethylamine oxide, pentadecyldimethylamine oxide, stearyldimethylamine oxide, hexadecyldimethylamine oxide, heptadecyldimethylamine oxide, octadecyldimethylamine oxide, stearyldimethylamine oxide, or any combination thereof.

In one embodiment, the amine oxide of the present disclosure may be obtained from a tertiary amine such that the amine oxide is a trialkylamine oxide. In one embodiment, the saturated or unsaturated groups may comprise coco, hydrogenated tallow, or soya. In one embodiment, the amine oxide may be derived from a mixture of coconut fatty acids such that it is a cocoalkylamine oxide such as a cocodimethylamine oxide.

In one embodiment, the composition may comprise more than one amine oxide identified by Formula (I). For instance, the composition may comprise any of the above amine oxides in combination.

In one embodiment, the composition may comprise a combination of at least a dodecyldimethylamine oxide, a tetradecyldimethylamine oxide, and a hexadecyldimethylamine oxide. In another embodiment, a combination of amine oxides may be utilized wherein the R1 group has the following chain distribution wherein the % is based on the total number of R1 carbon chains: C₁₀ (0-10%, such as 0-5%), C₁₂ (60-80%, such as 65-75%), C₁₄ (20-40%, such as 25-35%), C₁₆ (5-15%, such as 5-10%), C₁₈ (0-10%, such as 0-5%). The average chain length of all of the R1 groups of the amine oxides may be from about 10 to about 20 carbons, such as from about 11 to about 17 carbons, such as from about 12 to about 14 carbons. As such, the amine oxides may be comprised of primarily a C₁₂ amine oxide, such as a C₁₂ dimethylamine oxide such that the C₁₂ amine oxide is present in an amount greater than the other amine oxides.

Generally, long chain (C₁₆ or greater) amine oxides may impart waterproofing properties to the composition. Generally, short chain (shorter than C₁₆) amine oxides may aid in water solubility and solubilizing long chain amine oxides. The short chain amine oxides may also serve as preservatives. As such, in one embodiment, a blend of long chain and short chain amine oxides may be used according to the present disclosure. For instance, the composition may contain a mixture of C₁₆₋₁₈ long chain amine oxides to impart waterproofing properties and C₁₂₋₁₄ short chain amine oxides to solubilize the long chain amine oxides. The short chain amine oxides may be blended with the long chain amine oxides at a weight ratio of greater than about 1:10, such as greater than about 1:5, such as greater than about 1:2 and less than about 10:1, such as less than about 5:1, such as less than about 2:1.

The amine oxide may be present in solution and may have a pH of from about 6.0 to about 9.0, such as from about 6.5 to about 8.0. The amine oxide solution may have a peroxide content of less than about 1 wt. %, such as less than about 0.5 wt. %, such as less than about 0.2 wt. %, based on the weight of the solution.

Commercially available examples of amine oxides that may be used according to the present disclosure are marketed under the name Barlox® by Lonza of Allendale, N.J.

In addition, the amine oxides of the present disclosure may be non-toxic and function as surfactants. For instance, the amine oxides may be capable of dissolving the N-containing compounds of the present composition identified below. The amine oxides may also be capable of cleaning the surface of a metal substrate by facilitating the removal of oils, grease, and other materials.

According to the present disclosure, the composition is further comprised of at least one N-containing compound. The N-containing compound may have the following general formula identified as Formula (II):

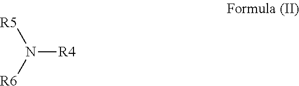

In one embodiment, R4 may be a linear, branched, cyclic, or any combination thereof of a C₁₋₄₀ saturated or unsaturated group, such as a C₁₋₂₀ saturated or unsaturated group or a C₆₋₄₀ saturated or unsaturated group, such as a C₁₋₁₀ saturated or unsaturated group or a C₆₋₂₂ saturated or unsaturated group, such as a C₁₋₅ saturated or unsaturated group or such as a C₈₋₁₈ saturated or unsaturated group. R4 may be an alkyl group, an alkenyl group, an alkynyl group, a hydroxyalkyl group, an alkoxy group, or an aminoalkyl group.

R5 and R6 each independently of one another may be a H or a linear, branched, cyclic, or any combination thereof of a C₁₋₄₀ saturated or unsaturated group, such as a C₁₋₂₀ saturated or unsaturated group, such as a C₁₋₁₀ saturated or unsaturated group, such as a C₁₋₅ saturated or unsaturated group. R5 and R6 each independently may be a H or an alkyl group, an alkenyl group, an alkynyl group, a hydroxyalkyl group, an alkoxy group, or an aminoalkyl group.

In one embodiment, R5 and R6 may be different. For instance, in one embodiment, R5 and R6 may be any of the groups mentioned above. For instance, in one embodiment, R5 and R6 may each independently of one another be a H, an aminoalkyl group such as an aminopropyl group, or an alkyl group such as a methyl group. In another embodiment, R5 and R6 may be the same. For instance, in one embodiment, R5 and R6 may both be the same group of any of the groups mentioned above. For instance, in one embodiment, R5 and R6 may both be alkyl groups such as a C₁₋₅ alkyl group such as a methyl group. For instance, in another embodiment, R5 and R6 may both be aminoalkyl groups such as a C₁₋₅ aminoalkyl group such as an aminopropyl group. For instance, in another embodiment, R5 and R6 may both be a H.

R5 and R6 may also be taken together in combination with the N to which it is attached to form a cyclic or heterocyclic group such as a morpholine, an isoxazole, an imidazole, an imidazoline, an imidazolidine, a pyrrole, a pyrrolidine, a piperazine, a piperidine, a pyrazine, a pyrimidine, a pyridazine, a pyrazolidine, an oxazole, an oxadiazole, an oxazolidine, a triazole, and the like. For instance, the N-containing compound may be a morpholine derivative, an isoxazole derivative, an imidazole derivative, an imidazoline derivative, an imidazolidine derivative, a pyrrole derivative, a pyrrolidine derivative, a piperazine derivative, a piperidine derivative, a pyrazine derivative, a pyrimidine derivative, a pyridazine derivative, a pyrazolidine derivative, an oxazole derivative, an oxadiazole derivative, an oxazolidine derivative, a triazole derivative, and the like such that R4 branches from the N to which R5 and R6 are attached.

The cyclic or heterocyclic group may be substituted or unsubstituted. For instance, the cyclic or heterocyclic group may have a second group branching from the cyclic or heterocyclic group in addition to the R4 group as identified above. The second group may be a linear, branched, cyclic, or any combination thereof of a C₁₋₄₀ saturated or unsaturated group, such as a C₁₋₂₀ saturated or unsaturated group or a C₆₋₄₀ saturated or unsaturated group, such as a C₁₋₁₀ saturated or unsaturated group such or a C₆₋₂₂ saturated or unsaturated group, such as a C₁₋₅ saturated or unsaturated group or a C₁₀₋₂₀ saturated or unsaturated group, such as a C₁₅-C₂₀ saturated or unsaturated group. This second group may be an alkyl group, an alkenyl group, an alkynyl group, a hydroxyalkyl group, an alkoxy group, or an aminoalkyl group.

The alkyl groups, alkenyl groups, alkynyl groups, hydroxyalkyl groups, alkoxy groups, and aminoalkyl groups may be any groups known in the art. For instance, the alkyl groups may include, but are not limited to methyl, ethyl, propyl, isopropyl, butyl, isobutyl, sec-butyl, tert-butyl, pentyl, isopentyl, hexyl, heptyl, octyl, nonyl, isononyl, decyl, dodecyl, tetradecyl, hexadecyl, octadecyl and icosyl, and the like. The hydroxyalkyl groups may include, but are not limited to, hydroxymethyl, hydroxylethyl, hydroxypropyl, etc. The alkoxy groups may include, but are not limited to, methoxy, ethoxy, butoxy, etc. The aminoalkyl groups may include, but are not limited to, methylamine, ethylamine, propylamine, etc. However, it should be understood that the groups are not limited to those listed. These groups may include any number of carbons within the C₁₋₄₀ saturated or unsaturated groups as defined for R4, within the C₁₋₄₀ saturated or unsaturated groups as defined for R5 and R6, and within the C₁₋₄₀ saturated or unsaturated groups as defined for the substituting group on the cyclic or hetercyclic compound.

The N-containing compound of the present disclosure may include a dialkylmethylamine, an alkyldimethylamine, dialkylamines, diamines, triamines, or any combination thereof. In one embodiment, the amine of the present disclosure may be a C₈₋₂₂ alkyldimethylamine, such as a C₈₋₁₈ alkyldimethylamine, such as a C₁₆₋₁₈ alkyldimethylamine or such as a C₁₂₋₁₆ alkyldimethylamine, such as a C₁₂₋₁₄ alkyldimethylamine, or any combination thereof.

The N-containing compound of the present disclosure may employ primary amines, secondary amines, tertiary amines, or a combination thereof. In one embodiment, the composition comprises at least one tertiary amine. In one embodiment, the N-containing compounds are comprised primarily of tertiary amines. For instance, the N-containing compounds may be comprised of greater than about 50%, such as greater than about 75%, such as greater than about 90%, such as greater than about 95% of tertiary amines, based on the total amount of N-containing compounds. For instance, the N-containing compounds may be comprised of less than about 5%, such as less than about 1%, such as less than about 0.5%, such as less than about 0.3% of primary and secondary amines, based on the total amount of N-containing compounds.

In one embodiment, R5 and R6 in combination with the N to which they are attached may form a heterocycle such as a morpholine. The morpholine may have the following general formula identified as Formula (III):

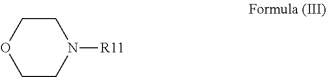

The R11 group is defined the same as the R4 group above. For instance, R11 may be a linear, branched, cyclic, or any combination thereof of a C₁₋₄₀ saturated or unsaturated group, such as a C₁₋₂₀ saturated or unsaturated group or a C₆₋₄₀ saturated or unsaturated group, such as a C₁₋₁₀ saturated or unsaturated group or a C₆₋₂₂ saturated or unsaturated group, such as a C₁₋₅ saturated or unsaturated group or such as a C₈₋₁₈ saturated or unsaturated group. R4 may be an alkyl group, an alkenyl group, an alkynyl group, a hydroxyalkyl group, an alkoxy group, or an aminoalkyl group.

In one embodiment, the compound of Formula (III) may be a C₆₋₂₄ alkylmorpholine, such as a C₈₋₂₀ alkylmorpholine, such as a C₁₀₋₁₆ alkylmorpholine, or any combination thereof. In one embodiment, R11 may be an alkyl group such as a C₁₂ alkyl.

It should be understood that the morpholine identified by Formula (III) may also be a substituted morpholine wherein the H atoms on the carbons of the morpholine heterocycle are replaced or substituted. For instance, substitution may occur at the 2, 3, 5, and/or 6 positions of the morpholine heterocycle. For instance, the morpholine may have a second group branching from the morpholine heterocycle in addition to the R11 group as identified above. The second group may be a linear, branched, cyclic, or any combination thereof of a C₁₋₄₀ saturated or unsaturated group, such as a C₁₋₂₀ saturated or unsaturated group or a C₆₋₄₀ saturated or unsaturated group, such as a C₁₋₁₀ saturated or unsaturated group or a C₆₋₂₂ saturated or unsaturated group, such as a C₁₋₅ saturated or unsaturated group or a C₁₀₋₂₀ saturated or unsaturated group, such as a C₁₅₋₂₀ saturated or unsaturated group. This second group may be an alkyl group, an alkenyl group, an alkynyl group, a hydroxyalkyl group, an alkoxy group, or an aminoalkyl group.

The morpholine may be a morpholine derivative such that the R11 group is attached to the N in the morpholine heterocycle. As such, the R11 group may be attached to the 4-position of the heterocycle.

In one embodiment, R5 and R6 in combination with the N to which they are attached may form a heterocycle such as an imidazoline. The imidazoline may have the following general formula identified as Formula (IV):

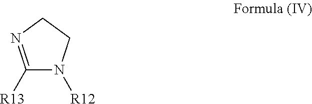

The R12 group is defined the same as the R5 or R6 group above. For instance, R12 may be a linear, branched, cyclic, or any combination thereof of a C₁₋₄₀ saturated or unsaturated group, such as a C₁₋₂₀ saturated or unsaturated group, such as a C₁₋₁₀ saturated or unsaturated group, such as a C₁₋₅ saturated or unsaturated group. R12 may be a H or an alkyl group, an alkenyl group, an alkynyl group, a hydroxyalkyl group, an alkoxy group, or an aminoalkyl group. In one embodiment, R12 may be a hydroxyalkyl such as a C₁₋₁₀ hydroxyalkyl, such as a C₁₋₅ hydroxyalkyl, such as a hydroxyethyl group.

It should be understood that the imidazoline identified by Formula (IV) may be a substituted imidazoline wherein the H atoms on the carbons of the imidazoline heterocycle are replaced or substituted. For instance, substitution may occur at the 2, 4, and/or 5 positions of the imidazoline heterocycle. As indicated in Formula (IV), the imidazoline may also be substituted with an R13 group at the 2 position. However, it should be understood that the imidazoline may also be unsubstituted such that the R13 is a H.

When substituted, R13 may be a linear, branched, cyclic, or any combination thereof of a C₆₋₄₀ saturated or unsaturated group, such as a C₆₋₂₂ saturated or unsaturated group, such as a C₁₀₋₂₀ saturated or unsaturated group, such as a C₁₅₋₂₀ saturated or unsaturated group. R13 may be an alkyl group, an alkenyl group, or an alkynyl group. In one embodiment, R13 is an alkenyl group, such as a C₁₀₋₂₀ alkenyl group, such as a C₁₅₋₂₀ alkenyl group, such as a C₁₇ alkenyl group.

Specific examples of N-containing compounds that may be used according to the present disclosure include, but are not limited to, isononyldimethylamine, decyldimethylamine, lauryldimethylamine, undecyldimethylamine, isododecyldimethylamine dodecyldimethylamine, cocodimethylamine, isotridecyldimethalamine, tetradecyldimethylamine, hexadecyldimethylamine, heptadecyldimethylamine, octadecyldimethylamine, octyldimethylamine, dodecylamine, stearyldimethylamine, and the like, and any combination thereof.

Specific examples of N-containing compounds that may be used according to the present disclosure include, but are not limited to, octyl morpholine, nonyl morpholine, decyl morpholine, undecyl morpholine, dodecyl morpholine, tridecyl morpholine, lauryl morpholine, cetyl morpholine, tetradecyl morpholine, hexadecyl morpholine, heptadecyl morpholine, octadecyl morpholine, and the like, and any combination thereof. In one embodiment, the N-containing compound may be 4-dodecylmorpholine.

Specific examples of N-containing compounds that may be used according to the present disclosure include, but are not limited to, 1-(2-hydroxyethyl)-2-decyl-2-imidazoline, 1-(2-hydroxyethyl)-2-dodecyl-2-imidazoline, 1-(2-hydroxyethyl)-2-tridecyl-2-imidazoline, 1-(2-hydroxyethyl)-2-tetradecyl-2-imidazoline, 1-(2-hydroxyethyl)-2-pentadecyl-2-imidazoline, 1-(2-hydroxyethyl)-2-heptadecyl-2-imidazoline, 1-(2-hydroxyethyl)-2-hexadecyl-2-imidazoline, 1-(2-hydroxyethyl)-2-heptadecenyl-2-imidazoline, 1-(2-hydroxyethyl)-2-octadecyl-2-imidazoline, and the like, and any combination thereof. In addition, the composition may comprise an unsaturated substitution group such as a decenyl group, a dodecenyl group, a tridecenyl group, a heptadecenyl group, an octyldecenyl group, and the like. In addition, instead of ethanol or hydroxyethyl, the functional group at the 1 position may be a methanol or hydroxymethyl, a propanol or hydroxypropyl, a butanol or hydroxybutyl, and the like, and any combination thereof.

Specific examples of N-containing compounds that may be used according to the present disclosure include, but are not limited to, bis(3-aminopropyl)-dodecylamine, N,N-bis(3-aminopropyl)-dodecylamine, bis(3-aminopropyl)octylamine, N,N-bis(3-aminopropyl)-octylamine, bis(3-aminopropyl)-nonylamine, N,N-bis(3-aminopropyl)-nonylamine, N-(3-aminopropyl)-N-dodecylpropane-1,3-diamine, and the like, or any combination thereof. In addition, instead of aminopropyl, the functional group at the 1 position may be an aminomethyl, an aminoethyl, aminobutyl, and the like, or any combination thereof.

The N-containing compound may include any combination of those compounds identified above. For instance, the N-containing compound may include any combination of primary amines, secondary amines, tertiary amines, morpholines, isoxazoles, imidazoles, imidazolines, imidazolidines, pyrroles, pyrrolidines, piperazines, piperidines, pyrazines, pyrimidines, pyridazines, pyrazolidines, oxazoles, oxadiazoles, oxazolidines, triazoles, and the like as identified above.

In one embodiment, the saturated or unsaturated groups may comprise coco, hydrogenated tallow, or soya. In one embodiment, the N-containing compound may include a group derived from a mixture of coconut fatty acids and may thus be a cocoalkylamine such as a cocodimethylamine.

In one embodiment, the composition may comprise more than one N-containing compound as identified above. For instance, the composition may comprise any of the above listed N-containing compounds in combination. In one embodiment, the composition may comprise a combination of at least a dodecyldimethylamine, a tetradecyldimethylamine, a hexadecyldimethylamine, or any combination thereof, In one embodiment, a combination of N-containing compounds may be utilized that have the following chain distribution wherein the % is based on the number of carbon chains: C₈ (0-20%, such as 5-15%), C₁₀ (0-20%, such as 5-15%), C₁₂ (30-80%, such as 40-75%), C₁₄ (15-40%, such as 20-30%), C₁₆ (0-20%, such as 5-15%), C₁₈ (0-15%, such as 1-10%). In one embodiment, the N-containing compounds may comprise the following chain distribution wherein the % is based on the number of carbon chains: C₁₂ (55-80%, such as 60-75%), C₁₄ (1 5-40%, such as 20-30%), C₁₆ (0-20%, such as 3-9%). In another embodiment, the N-containing compounds may comprise the following chain distribution: C₁₂ (30-60%, such as 40-55%), C₁₄ (15-40%, such as 20-30%), C₁₆ (0-20%, such as 5-15%). As such, the N-containing compounds may be comprised of primarily a C₁₂ groups and/or C₁₂ amines, such as a C₁₂ dimethylamines such that the C₁₂ group is present in an amount greater than the other groups in the N-containing compounds.

Commercially available examples of N-containing compounds that may be used according to the present disclosure are marketed under the name Barlene™ Lonzabac®, and Unamine™ by Lonza of Allendale, N.J.

The composition of the present disclosure may also comprise a solvent. The composition may be an aqueous-based composition or a non-aqueous based composition. The solvent may be a polar solvent such as water or a water miscible polar solvent, an alcohol, a glycol, a glycol ether such as propylene glycol, an ester, an ether, a polyether, an amine, a ketone, and mixtures thereof. In one embodiment, the solvent of the composition is water.

The pH of the composition may be from greater than about 4, such as greater than about 5, such as greater than about 6 and less than about 13, such as less than about 12, such as less than about 11.

The composition of the present disclosure may comprise other conventional additives such as builders, colorants, perfumes/fragrances/scents, cleaners, iron stain inhibitors, wetting agents, adhesives, fillers, carriers, UV stabilizers, curing agents, hardening agents, flame retardants, viscosity or rheological modifiers, pH regulators, defoamers, and mixtures thereof.

In one embodiment, the composition of the present disclosure comprises a defoamer. The defoamers may include methyl silicone oil, fluorosilicone oil, a polyacrylate, mineral oils and waxes, and the like. The defoamer is blended in the stock solution so that the defoamer is contained in an amount of greater than about 0.004%, such as greater than about 0.01%, such as greater than about 0.1%, such as greater than about 0.5% and less than about 1.5%, such as less than about 1%, such as less than about 0.5%, such as less than about 0.1% of the total amount of the final diluted, ready to use composition or fluid.

According to one embodiment, the composition may further contain quaternary ammonium compounds having the following general formula:

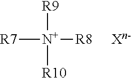

R₇ may be an optionally aryl-substituted C₁₋₂₀ alkyl group, R₈ may be an optionally aryl-substituted C₁₋₂₀ alkyl group, R₉ and R₁₀ independently of each other may be C₁₋₄ alkyl groups, Xⁿ⁻ may be an anion selected from the group consisting of hydroxide, carbonate, bicarbonate, phosphates, phosphites, hypophosphite, nitrate, sulfates, borates, anions of saturated and unsaturated acyclic C₁₋₂₀ monocarboxylic acids, anions of saturated and unsaturated C₂₋₂₀ dicarboxylic acids, and anions of hydroxy-substituted carboxylic acids, and n may denote the appropriate number of negative charges of said anion.

The C₁₋₂₀ alkyl groups may be linear or branched alkyl groups having 1 to 20 carbon atoms, including, but not limited to, methyl, ethyl, propyl, isopropyl, butyl, isobutyl, sec-butyl, tert-butyl, pentyl, isopentyl, hexyl, heptyl, octyl, nonyl, isononyl, decyl, dodecyl, tetradecyl, hexadecyl, octadecyl and icosyl. Aryl-substituted C₁₋₂₀ alkyl groups may be any of the above groups bearing an aryl group, in particular phenyl, as a substituent. These aryl-substituted C₁₋₂₀ alkyl groups may include benzyl, phenylethyl and phenylpropyl.

In one embodiment, the R₉ and R₁₀ groups may be the same alkyl group such as C₁₋₄ alkyl groups such as methyl groups. In one embodiment, the R₇ and R₈ groups may be the same alkyl groups such as C₁₋₂₀ alkyl groups such as C₁₀ alkyl groups. In one embodiment, the quaternary ammonium compound may be a didecyldimethyl ammonium salt such as a didecyldimethyl ammonium carbonate and/or didecyldimethyl ammonium bicarbonate. In one embodiment, the quaternary ammonium compound may be a non-halide such as a non-chloride quaternary ammonium compound.

The quaternary ammonium compounds may be present in an amount of greater than about 1% by weight, such as greater than about 5% by weight, such as greater than about 10% by weight and less than about 30% by weight, such as less than about 20% by weight, such as less than about 15% by weight. According to an alternative embodiment, the composition may be substantially free (i.e., contains less than about 0.1% by weight, such as less than about 0.01% by weight, such as about 0% by weight) of quaternary ammonium compounds.

According to one embodiment, the composition may be substantially free (i.e., contains less than about 0.1% by weight, such as less than about 0.01% by weight, such as about 0% by weight) of halogenated compounds (including halides and chlorinated compounds such as chlorophenols), alkanolamines, or any combination hereof.

In one embodiment, the composition of the present disclosure may comprise an organic binder. As such, the composition of the present disclosure may be utilized as an anticorrosive paint or coating for a metal substrate. The binder may be selected from the group consisting of acrylic resins, casein (milk protein), vinyl resins, latex resins, acetate resins, epoxy resins, urethane resins, butyral resins, phthalic acid resins, curable resins such as isocyanate and butadiene resins, and mixtures thereof. As such, the paint may be a latex paint, an enamel spray paint, an E-Coating paint, an acrylic paint or a primer. When present, the binder may be present in the composition in an amount of at least about 0.5 wt. %, such as at least about 1 wt. %, such as at least about 2.5 wt. %, such as at least about 5 wt. % and less than about 20 wt. %, such as less than about 15 wt. %, such as less than about 10 wt. %.

In one embodiment, the composition of the present disclosure may comprise a surfactant such as a non-ionic surfactant, cationic surfactant, anionic surfactant, amphoteric surfactants, and mixtures thereof. The surfactant may include amine oxides other than the amine oxides disclosed above, linear alcohol ethoxylates, secondary alcohol ethoxylates, ethoxylate ethers, betaines, alkyl polyglycerides, fatty acids containing from 6 to 22 carbon atoms and salts of said fatty acids, or any combination thereof. When present, the surfactant may be present in the composition in an amount of at least about 0.1 wt. %, at least about 0.5 wt. %, such as at least about 1 wt. %, such as at least about 2.5 wt. %, such as at least about 5 wt. % and less than about 20 wt. %, such as less than about 15 wt. %, such as less than about 10 wt. %, such as less than about 5 wt. %.

The composition of the present invention may be used to inhibit the corrosion of substrates such as metal substrates. As such, the composition prevents or reduces the rate of oxidation of a metal surface, generally when the metal is exposed to water or air, or a combination of the two. Not to be limited by theory, it is believed that the composition of the present disclosure migrates to the surface of the metal substrate and blocks oxygen and/or air form causing further oxidation of the metal substrate surface. As such, the composition of the present disclosure may first be applied to the metal substrate and thereafter a paint may be applied to the coated metal substrate.

The composition or anticorrosive paint or coating may be applied to a substrate such that the substrate is painted or coated with the anticorrosive paint and/or composition. They can be applied to a substrate by any means known in the art, including, but not limited to coating, depositing, dipping, soaking, brushing, spraying, mopping, washing, soaking, immersing, or the like. When applied to a metal substrate, the composition may promote adhesion of a paint or coating to the metal substrate. The present inventors have discovered that the composition of the present disclosure may be utilized as a conversion coating which may react with the metal substrate such as the surface of the substrate to form a rough surface for mechanical and/or chemical adhesion of an organic polymer to the surface. Not to be bound by any particular theory, it is believed that the N-containing compounds and/or amine oxides have a natural affinity for the metal, since they may also act as cationic surfactants, and therefore migrate to the surface of the metal. Once at the surface, they block oxygen and/or air from causing further oxidation of the metal surface.

The metal substrate may generally be a metal surface. For instance, the metals may include, but are not limited to, iron, copper, aluminum, brass, tin, zinc, and iron alloys such as steel, metal alloys, cast iron.

The metal substrate containing the composition generally comprises from about 0.1 to about 10% by weight, such as from about 0.1 to about 5% by weight, such as from about 0.1 to about 2% by weight of the composition, based upon 100% of total weight of metal substrate. The initial thickness of the coating on the metal substrate may be less than about 500 nanometers, such as less than about 250 nanometers, such as less than about 100 nanometers and greater than about 1 nm, such as greater than about 10 nm, such as greater than about 25 nm. In one embodiment, the coating may be a monolayer coating. In an alternative embodiment, the coating may be a multilayer coating such as a bilayer coating.

The composition of the present disclosure may be utilized as a metalworking fluid. These fluids are used to reduce heat and friction and to remove metal particles during metalworking processes. For instance, the composition may be utilized to cool and/or lubricant metalworking processes such as turning, grinding, boring, drawing, tapping, gear shaping, reaming, rolling, hobbing, and band- and hack-sawing. The composition may improve the quality of the workpiece by continuously removing the fines, chips, and swarfs from the tool being used and the surface of the workpiece.

The composition of the present invention may be provided in a concentrated form or in a ready to use form which has been diluted. In view of handling ability, the composition of the present disclosure may be water based and may be prepared as a stock solution having a high concentration so that the user dilutes the fluid as necessary with water to use the diluted fluid as desired.

According to one embodiment, the composition in concentrated form may contain at least 1 wt. %, such as at least 5 wt. %, such as at least 10 wt. % and generally less than about 50 wt. %, such as less than about 40 wt. %, such as less than about 30 wt. %, such as less than about 25 wt. % of the amine oxide(s). According to one embodiment, the composition in a concentrated form may contain at least 1 wt. %, such as at least 5 wt. %, such as at least 10 wt. % and generally less than about 50 wt. %, such as less than about 35 wt. %, such as less than about 25 wt. %, such as less than about 20 wt. % of the N-containing compound(s).

The weight ratio of the amine oxide(s) to the N-containing compound(s) is at least about 1:10, such as at least about 1:5, such as at least about 1:2 and generally less than about 10:1, such as less than about 5:1, such as less than about 3:1, such as less than about 2.5:1.

When a water based solution is used, the above concentrated solution may be diluted with water in an amount of at least 5 times, such as at least 10 times, and less than about 200 times, such as less than about 100 times, such as less than about 50 times, such as less than about 30 times.

According to one embodiment, the composition in a ready to use form may contain at least 25 wt. %, such as at least 35 wt. % water, such as at least 50 wt. % water, such as at least 60 wt. % water and less than about 90 wt. %, such as less than about 80 wt. % water, such as less than about 75 wt. % water, such as less than about 70 wt. % water.

Generally, the ready to use form may have a concentration of at least 10 ppm, such as at least 100 ppm, such as at least 500 ppm, such as at least 750 ppm and generally less than about 50,000 ppm, such as less than about 25,000 ppm, such as less than about 10,000 ppm, such as less than about 7,500 ppm, based on the total weight of the composition.

In addition to the advantages provided above, the composition of the present disclosure may impart or exhibit antimicrobial efficacy. The coating and/or composition may include an effective amount of the composition or of a different antimicrobial agent to impart or exhibit antimicrobial efficacy.

In addition, since the amine oxides may aide in solubilizing the N-containing compound, the solution formed from the combination of both components may be comprised of only one phase. In addition, the compositions may exhibit low volatility.

In addition, it has been found that the composition of the present invention may exhibit certain self-healing properties on scratching. Thus, a bare metal surface in a scratch may show some passivation that may be due to migration of the coating composition from the surrounding coating. In some cases, a permanent oxide transformation may be also observed resulting in long term passivation of a scratched area.

Furthermore, the composition of the present disclosure allows for a one step metal surface preparation process prior to final coating applications. The compositions of the present disclosure simultaneously may clean the metal substrate, provide the substrate with corrosion inhibition, and primer coat metal surfaces in preparation for final coating applications.

The present disclosure may be better understood with reference to the following example.

### EXAMPLES

The examples of the invention are given below by way of illustration and not by way of limitation. The following experiments were conducted in order to show some of the benefits and advantages of the present invention.

In the Examples below, the following materials were used to prepare the formulations:

Barlox® 12 is an aqueous solution containing 30% by weight of cocodimethylamine oxide available from Lonza Inc. of Allendale, N.J.

Barlene™ 12 is a liquid containing 100% by weight of dodecyldimethylamine available from Lonza Inc. of Allendale, N.J.

Barlene™12C is a liquid containing 100% by weight of cocodimethylamine available from Lonza Inc. of Allendale, N.J.

Barlene™ LM is a liquid containing 100% by weight of laurylmorpholine available from Lonza Inc. of Allendale, N.J.

Unamine™ O is a liquid containing 100% by weight of 1-hydroxyethyl, 2-heptadecenyl imidazoline available from Lonza Inc. of Allendale, N.J.

Lonzabac® 12.30 is an aqueous solution containing 25-35% by weight of N-(3-aminopropyl)-N-dodecylpropane-1,3-diamine.

### Example 1

The following example was used to evaluate the corrosion inhibition property of the formulations of the present disclosure.

The formulations based on the amine oxides and N-containing compounds were prepared based on the percentages as provided in Table 1.

TABLE 1
Formulations

| | Form- | Form- | Form- |
|---|---|---|---|
| | ulation A | ulation B | ulation C |
| Lonzabac ® 12.30 | 50.00 | — | — |
| (wt %) | | | |
| Barlox ® 12 (wt %) | 50.00 | 66.67 | 66.67 |
| Barlene ™ 12 (wt %) | — | 10.00 | — |
| Barlene ™ 12C | — | — | 10.00 |
| (wt %) | | | |
| DI Water (wt %) | — | 23.33 | 23.33 |

Carbon steel 1010 coupons (from Q-panel Lab Products in Cleveland, Ohio) of 0.032 by 1 by 3 inches were obtained and initially weighed. The coupons were submerged in a glass jar containing Formulation A, Formulation B, and/or water. The coupons were at least % covered and stored for one week. The samples and respective amounts of each formulation are identified in Table 2 below. The samples comprised 1000 or 5000 ppm of the prepared formulations with the balance water. Each solution was tested with three coupons.

TABLE 2
Formulation Concentrations

| | Sam- | Sam- | Sam- | Sam- | Sam- |
|---|---|---|---|---|---|
| | ple 1 | ple 2 | ple 3 | ple 4 | ple 5 |
| Formulation | 0 | 1000 | 5000 | 0 | 0 |
| A (ppm) | | | | | |
| Formulation | 0 | 0 | 0 | 1000 | 5000 |
| B (ppm) | | | | | |

After one week, the coupons were removed, rinsed with tap water, and brushed gently with a soft nylon brush. The coupons were then dried under a stream of nitrogen and weighed. The results are listed in Table 3 below.

Differences in weight are expressed as (−) for weight loss or (+) for weight gain. All weight differences and percents are based on the original weight of the respective coupon.

As shown in Table 3, solutions containing 1000 ppm or 5000 ppm of Formulation A or Formulation B caused substantially no corrosion on test coupons, as evidenced by substantially no weight loss or minimal weight loss of the coupon. In addition, substantially no sediment formation was observed for these samples.

The control solution, DI water, in Sample 1 became yellow brown and showed sediment on the bottom of the glass jar. Corrosion was observed on the carbon steel coupons exposed to deionized water, while substantially no corrosion was observed on the coupon exposed to the test formulations after one month. In fact, corrosion was observed on the carbon steel coupons exposed to deionized water after one hour.

TABLE 3
Sample Weights

| | Sam- | Sam- | Sam- | Sam- | Sam- |
|---|---|---|---|---|---|
| | ple 1 | ple 2 | ple 3 | ple 4 | ple 5 |
| Average Wt. | 12.2180 | 12.2174 | 12.2005 | 12.2151 | 12.2338 |
| (g) (Before) | | | | | |
| Average Wt. | 12.1923 | 12.2171 | 12.2008 | 12.2147 | 12.2336 |
| (g) (After) | | | | | |
| Wt. Change | −0.0257 | −0.0003 | +0.0003 | −0.0004 | −0.0002 |
| (g) | | | | | |
| Wt. Change | −0.2104 | −0.0025 | +0.0025 | −0.0033 | −0.0016 |
| (%) | | | | | |
| Sediment | Yes | No | No | No | No |
| Formation | | | | | |

### Example 2

The following example was used to evaluate the corrosion inhibition property of the formulations of the present disclosure.

Another set of corrosion tests were conducted with Formulation A, Formulation B, and Formulation C and a quaternary ammonium carbonate/bicarbonate formulation. The formulations based on the amine oxides and N-containing compounds were prepared based on the percentages as provided in Table 4.

TABLE 4
Formulations

| | Form- | Form- | Form- |
|---|---|---|---|
| | ulation A | ulation B | ulation C |
| Lonzabac ® 12.30 | 50.00 | — | — |
| (wt %) | | | |
| Barlox ® 12 (wt %) | 50.00 | 66.67 | 66.67 |
| Barlene ™ 12 (wt %) | — | 10.00 | — |
| Barlene ™ 12C | — | — | 10.00 |
| (wt %) | | | |
| DI Water (wt %) | — | 23.33 | 23.33 |

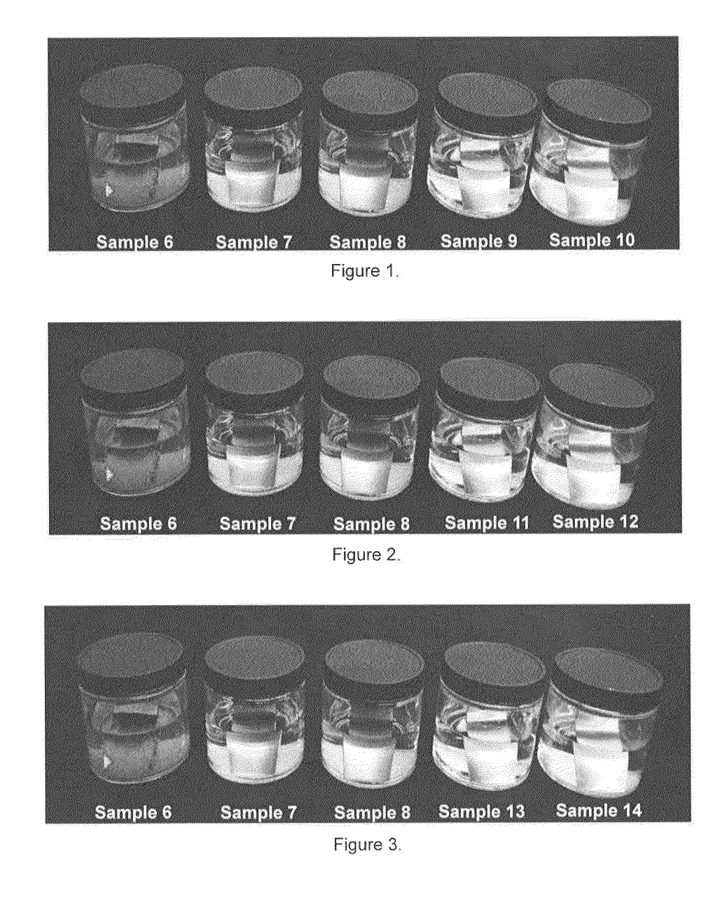

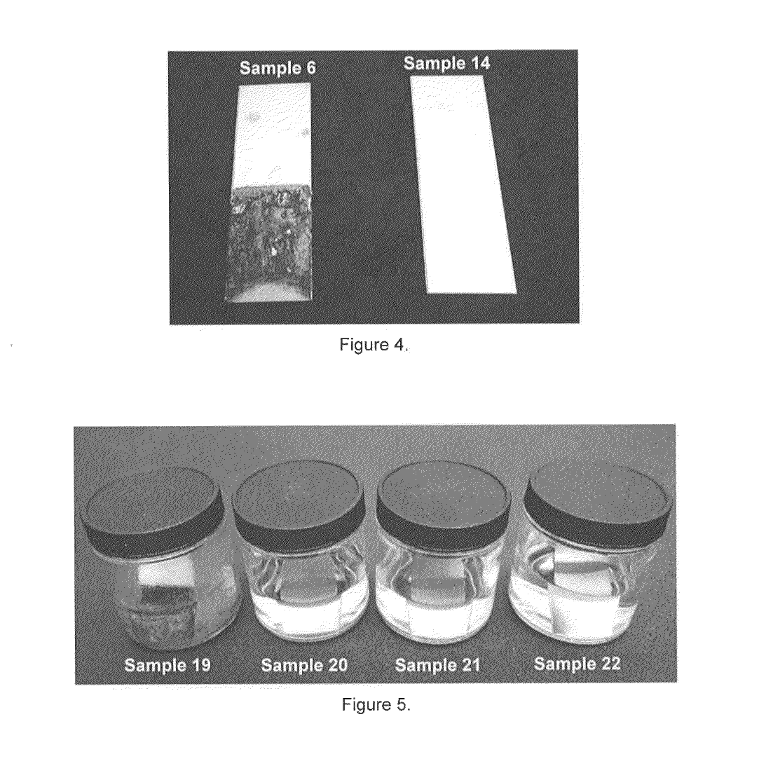

Carbon steel 1010 coupons (from Q-panel Lab Products in Cleveland, Ohio) of 0.032 by 1 by 3 inches were obtained. The coupons were submerged in a glass jar containing Formulation A, Formulation B, and/or water. The coupons were at least ¾ covered and stored for one month. The samples and respective amounts of each formulation are identified in Table 5 below. After one month, the coupons were removed, rinsed with tap water, and brushed gently with a soft nylon brush. The coupons were then dried under a stream of nitrogen. The results are provided in FIGS. 1-4.

TABLE 5
Formulation Concentrations

| | |
|---|---|
| Sample 6 | DI Water |
| Sample 7 | 30% didecyldimethylammonium |
| | carbonate/bicarbonate solution |
| Sample 8 | 0.5% didecyldimethylammonium |
| | carbonate/bicarbonate solution |
| Sample 9 | Formulation A (as is) |
| Sample 10 | 0.5% Formulation A |
| Sample 11 | Formulation B (as is) |
| Sample 12 | 0.5% Formulation B |
| Sample 13 | Formulation C (as is) |
| Sample 14 | 0.5% Formulation C |

As shown in FIGS. 1-4, corrosion was observed on the carbon steel coupons exposed to deionized water, while substantially no corrosion was observed on the coupons exposed to the quaternary ammonium carbonate/bicarbonate formulations and the test formulations based on the amine oxides and N-containing compounds after one month. In fact, corrosion was observed on the carbon steel coupons exposed to deionized water after one hour.

### Example 3

The following example was used to evaluate the corrosion inhibition property of the formulations of the present disclosure.

Another set of corrosion tests were conducted with Formulation D, Formulation E, and Formulation F and a quaternary ammonium carbonate/bicarbonate formulation. The formulations based on the amine oxides and N-containing compounds were prepared based on the percentages as provided in Table 6.

TABLE 6
Formulations

| | Form- | Form- | Form- |
|---|---|---|---|
| | ulation D | ulation E | ulation F |
| Barlox ® 12 (wt %) | 40.00 | 66.67 | 66.67 |
| Barlene ™ 12 (wt %) | 12.00 | — | — |
| Barlene ™ LM | — | 10.00 | — |
| (wt %) | | | |
| Unamine ™ O (wt %) | — | — | 20.00 |
| Carboshield ® 1000 | 24.00 | — | — |
| (wt %) | | | |
| DI Water (wt %) | 24.00 | 23.33 | 13.33 |

Carbon steel 1010 coupons (from Q-panel Lab Products in Cleveland, Ohio) of 0.032 by 1 by 3 inches were obtained and initially weighed. The coupons were submerged in a glass jar containing Formulation D, Formulation E, Formulation F, and/or water. The coupons were at least ¾ covered and stored for one week. The samples and respective amounts of each formulation are identified in Table 2 below. The samples may comprise 1000 or 5000 ppm of the prepared formulations. Each solution was tested with three coupons.

TABLE 7
Formulation

| | Sam- | Sam- | Sam- | Sam- |
|---|---|---|---|---|
| | ple 15 | ple 16 | ple 17 | ple 18 |
| Formulation | 0 | 1000 | 0 | 0 |
| D (ppm) | | | | |
| Formulation | 0 | 0 | 5000 | 0 |
| D (ppm) | | | | |
| Formulation | 0 | 0 | 0 | 1000 |
| F (ppm) | | | | |

After one week, the coupons were removed, rinsed with tap water, and brushed gently with a soft nylon brush. The coupons were then dried under a stream of nitrogen and weighed. The results are listed in Table 8 below.

Differences in weight are expressed as (−) for weight loss or (+) for weight gain. All weight differences are given in percent, based on the original weight of the respective coupon.

As shown in Table 8, solutions containing 1000 ppm or 5000 ppm of Formulation D, Formulation E, or Formulation F caused substantially no corrosion on test coupons, as evidenced by substantially no weight loss or minimal weight loss of the coupon. In addition, substantially no sediment formation was observed for these samples.

The control solution, DI water, in Sample 15 became yellow brown and showed sediment on the bottom of the glass jar. Corrosion was observed on the carbon steel coupons exposed to deionized water, while substantially no corrosion was observed on the coupon exposed to the test formulations after one month. In fact, corrosion was observed on the carbon steel coupons exposed to deionized water after one hour.

TABLE 8
Sample Weights

| | Sam- | Sam- | Sam- | Sam- |
|---|---|---|---|---|
| | ple 15 | ple 16 | ple 17 | ple 18 |
| Average Wt. | 12.2594 | 12.3028 | 12.2865 | 12.4386 |
| (g) (Before) | | | | |
| Average Wt. | 12.2385 | 12.3025 | 12.2862 | 12.4379 |
| (g) (After) | | | | |
| Wt. Change | −0.0209 | −0.0003 | −0.0003 | −0.0007 |
| (g) | | | | |
| Wt. Change | −0.1705 | −0.0024 | −0.0024 | −0.0056 |
| (%) | | | | |
| Sediment | Yes | No | No | No |
| Formation | | | | |

### Example 4

The following example was used to evaluate the corrosion inhibition property of the formulations of the present disclosure.

Another set of corrosion tests were conducted with Formulation D, Formulation E, and Formulation F and a quaternary ammonium carbonate/bicarbonate formulation. The formulations based on the amine oxides and N-containing compounds were prepared based on the percentages as provided in Table 9.

TABLE 9
Formulations

| | Form- | Form- | Form- |
|---|---|---|---|
| | ulation D | ulation E | ulation F |
| Barlox ® 12 (wt %) | 40.00 | 66.67 | 66.67 |
| Barlene ™ 12 (wt %) | 12.00 | — | — |
| Barlene ™ LM | — | 10.00 | — |
| (wt %) | | | |
| Unamine ™ O (wt %) | — | — | 20.00 |
| Carboshield ® 1000 | 24.00 | — | — |
| (wt %) | | | |
| DI Water (wt %) | 24.00 | 23.33 | 13.33 |

Carbon steel 1010 coupons (from Q-panel Lab Products in Cleveland, Ohio) of 0.032 by 1 by 3 inches were obtained. The coupons were submerged in a glass jar containing Formulation D, Formulation E, Formulation F, and/or water. The coupons were at least ¾ covered and stored for ten days. The samples and respective amounts of each formulation are identified in Table 10 below. After ten days, the coupons were removed, rinsed with tap water, and brushed gently with a soft nylon brush. The coupons were then dried under a stream of nitrogen. The results are provided in FIG. 5.

TABLE 10
Formulation Concentrations

| | |
|---|---|
| Sample 19 | DI Water |
| Sample 20 | 0.5% Formulation D |
| Sample 21 | 0.5% Formulation E |
| Sample 22 | 0.5% Formulation F |

As shown in FIG. 5, corrosion was observed on the carbon steel coupons exposed to deionized water, while substantially no corrosion was observed on the coupons exposed to a quaternary ammonium carbonate/bicarbonate formulations and the test formulations based on amine oxide and N-containing compounds after ten days. In fact, corrosion was observed on the carbon steel coupons exposed to deionized water after one hour.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part.

Furthermore, those of ordinary skill in the art will appreciate that the foregoing description is by way of example only, and is not intended to limit the invention so further described in such appended claims.

1. An anticorrosion composition comprising
at least one amine oxide having the formula 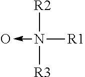
wherein
R1 is a linear, branched, or cyclic C₆₋₄₀ saturated or unsaturated group,
R2 and R3 are each independently of one another H or a linear, branched, or cyclic C₁₋₄₀ saturated or unsaturated group, and
at least one N-containing compound having the formula 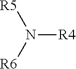
wherein
R4 is a linear, branched, or cyclic C₁₋₄₀ saturated or unsaturated group,
R5 and R6 are each independently of one another H or a linear, branched, or cyclic C₁₋₄₀ saturated or unsaturated group or R5 and R6 are both taken together in combination with the N to which they are attached to form a cyclic or heterocyclic group, optionally substituted.

2. The composition according to claim 1, wherein R1 is a C₆₋₁₈ alkyl group, alkenyl group, or alkynyl group.

3. The composition according to claim 1, wherein R2 and R3 are each independently of one another a H or a C₁₋₅ alkyl group.

4. The composition according to claim 1, wherein R4 is a C₈₋₁₆ alkyl group, alkenyl group, or alkynyl group.

5. The composition according to claim 1, wherein R5 and R6 are each independently of one another a H, a C₁₋₅ alkyl group, or a C₁₋₅ aminoalkyl group.

6. The composition according to claim 1, wherein the cyclic or heterocyclic group is a morpholine or an imidazoline.

7. The composition according to claim 1, wherein the composition comprises more than one amine oxide or more than one N-containing compound or a combination thereof, wherein the more than one amine oxide comprises at least a C₁₂, a C₁₄, and a C₁₆ alkyl and the more than one N-containing compound comprises at least a C₁₂, a C₁₄, and a C₁₆ alkyl.

8. The composition according to claim 1, wherein the N-containing compound comprises a tertiary amine and optionally a primary amine and a secondary amine, the tertiary amine comprising greater than about 50% of the N-containing compound and the primary amine and the secondary amine comprising less than about 5% of the N-containing compound.

9. The composition according to claim 1, wherein the amine oxide comprises a C₆₋₁₈ alkyldimethylamine oxide and the N-containing compound comprises a C₈₋₁₈ alkyldimethylamine, a morpholine, an imidazoline, or any combination thereof.

10. The composition according to claim 1, wherein the amine oxide comprises cocodimethyl amine oxide, dodecyldimethyl amine oxide, or a combination thereof.

11. The composition according to claim 1, wherein the N-containing compound is cocodimethyl amine, lauryldimethyl amine, N,N-bis(3-aminopropyl)-dodecylamine, N-(3-aminopropyl)-N-dodecylpropane-1,3-diamine, laurylmorpholine, dodecylmorpholine, 1-hydroxyethyl 2-heptadecenyl imidazoline, or a combination thereof.

12. The composition according to claim 1, wherein the composition comprises the amine oxide in an amount of from about 1 wt. % to about 40 wt. % and the N-containing compound in an amount of from about 1 wt. % to about 35 wt. %.

13. The composition according to claim 1, wherein the composition has a concentration of from about 10 ppm to about 25,000 ppm.

14. The composition according to claim 1, wherein the weight ratio of the amine oxide to the N-containing compound is from about 1:10 to about 10:1.

15. A method for inhibiting the corrosion of a metal, the method comprising
contacting a metal surface with an anticorrosion composition, the composition comprising
at least one amine oxide having the formula 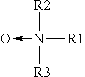
wherein
R1 is a linear, branched, or cyclic C₆₋₄₀ saturated or unsaturated group,
R2 and R3 are each independently of one another H or a linear, branched, or cyclic C₁₋₄₀ saturated or unsaturated group, and
at least one N-containing compound having the formula 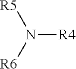
wherein
R4 is a linear, branched, or cyclic C₁₋₄₀ saturated or unsaturated group,
R5 and R6 are each independently of one another H or a linear, branched, or cyclic C₁₋₄₀ saturated or unsaturated group or R5 and R6 are both taken together in combination with the N to which they are attached to form a cyclic or heterocyclic group, optionally substituted.

16. The method according to claim 15, wherein R1 is a C₆₋₁₈ alkyl group, alkenyl group, or alkynyl group,

17. The method according to claim 15, wherein R2 and R3 are each independently of one another a H or a C₁₋₅ alkyl group.

18. The method according to claim 15, wherein R4 is a C₈₋₁₈ alkyl group, alkenyl group, or alkynyl group,

19. The method according to claim 15, wherein R5 and R6 are each independently of one another a H, a C₁₋₅ alkyl group, or a C₁₋₅ aminoalkyl group.

20. The method according to claim 15, wherein the cyclic or heterocyclic group is a morpholine or an imidazoline.

21. The method according to claim 15, wherein the composition comprises more than one amine oxide or more than one N-containing compound or a combination thereof, wherein the more than one amine oxide comprises at least a C₁₂, a C₁₄, and a C₁₆ alkyl and the more than one N-containing compound comprises at least a C₁₂, a C₁₄, and a C₁₆ alkyl.

22. The method according to claim 15, wherein the N-containing compound comprises a tertiary amine and optionally a primary amine and a secondary amine, the tertiary amine comprising greater than about 50% of the N-containing compound and the primary amine and the secondary amine comprising less than about 5% of the N-containing compound.

23. The method according to claim 15, wherein the amine oxide comprises a C₆₋₁₈ alkyldimethylamine oxide and the N-containing compound comprises a C₈₋₁₈ alkyldimethylamine, a morpholine, an imidazoline, or any combination thereof.

24. The method according to claim 15, wherein the amine oxide is cocodimethyl amine oxide, dodecyldimethyl amine oxide, or a combination thereof.

25. The method according to claim 15, wherein the N-containing compound is cocodimethyl amine, lauryldimethyl amine, N,N-bis(3-aminopropyl)-dodecylamine, N-(3-aminopropyl)-N-dodecylpropane-1,3-diamine, laurylmorpholine, dodecylmorpholine, 1-hydroxyethyl 2-heptadecenyl imidazoline, or a combination thereof.

26. The method according to claim 15, wherein the composition comprises the amine oxide in an amount of from about 1 wt. % to about 40 wt. % and the N-containing compound in an amount of from about 1 wt. % to about 35 wt. % and wherein the weight ratio of the amine oxide to the N-containing compound is from about 1:10 to about 10:1.

27. The method according to claim 15, wherein the composition has a concentration of from about 10 ppm to about 25,000 ppm.

28. The method according to claim 15, wherein the metal substrate comprises copper, iron, aluminum, tin, zinc, steel, metal alloys, or cast iron.

29. The method according to claim 15, further comprising providing a coating on the metal substrate.
